(19) United States
(12) Patent Application Publication
(10) Pub. No.: US 2023/0408644 A1
(43) Pub. Date: Dec. 21, 2023

(54) INTRINSIC NOISE CHARACTERIZATIONS FOR INCREASED RADAR SENSOR SENSITIVITY

(71) Applicant: GM CRUISE HOLDINGS LLC, San Francisco, CA (US)

(72) Inventor: Daniel Flores Tapia, Fairfield, CA (US)

(73) Assignee: GM CRUISE HOLDINGS LLC, San Francisco, CA (US)

(21) Appl. No.: 17/841,533

(22) Filed: Jun. 15, 2022

(51) Int. Cl. G01S 7/40; G01S 13/02

(52) U.S. Cl. CPC G01S 7/4008; G01S 7/4095; G01S 7/4021; G01S 13/02

(57) ABSTRACT

A radio detection and ranging (RADAR) system calibration and compensation approach is described. receive aa reference signal is received from a signal generation architecture. A pre-selected number of cycles of the reference signal are stored. A spectrum calculation is performed on the stored reference signal to generate a spectrum representation. Component analysis operations are performed on the spectrum representation to generate a set of coefficients. Non-linear classification is performed on the set of coefficients to determine collection cycle parameters. Noise parameters are estimated utilizing the coefficients and the collection cycle parameters. The noise parameters are phase noise parameter estimations and/or system characteristic colored noise parameter estimations. Point clouds can be generated using the noise estimation parameters.

### TECHNICAL FIELD

The present disclosure generally relates to calibration for radio detection and ranging (RADAR) systems and, more specifically, the present disclosure provides robust approaches for on-the-fly calibration and compensation for low-level sensor parameters (e.g., phase and colored noise) to support improved RADAR sensor sensitivity.

### BACKGROUND

Autonomous vehicles, also known as self-driving cars, driverless vehicles, and robotic vehicles, may be vehicles that use multiple sensors to sense the environment and move without human input. The sensors (and sensor systems) can include cameras and/or RADAR systems to provide information about the autonomous vehicle operating environment to control systems of the autonomous vehicle. Automation technology in the autonomous vehicles may enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating driving safety. The autonomous vehicles can be used to pick up passengers and drive the passengers to selected destinations. The autonomous vehicles can also be used to pick up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a block diagram of an example autonomous vehicle.

FIG. 2 a block diagram of an example automotive radar system illustrating transmit and receive capability.

FIG. 3 is a block diagram of an architecture that can provide calibration and compensation of phase noise.

FIG. 4 is a block diagram of an architecture that can provide calibration and compensation of system characteristic colored noise.

FIG. 5 illustrates an example autonomous vehicle management architecture.

FIG. 6 is a flow diagram for one technique for calibration and compensation of noise in a RADAR system.

FIG. 7 is a block diagram of one example of a processing system that can provide calibration and compensation of noise in a RADAR system.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Current automotive radar systems have limited self-diagnostic capabilities that are mostly limited to sensor source absolute phase and silicon temperature. These capabilities are sufficient for human-operated vehicles where the vehicle operator can detect and distinguish small targets in an operating environment and the larger targets (e.g., cars, trucks, bridges) can be detected and distinguished by the vehicle sensor systems. This can be sufficient in a human-operated vehicle having an advanced driver assistance system (ADAS).

However, when operating autonomously, the RADAR sensors should have greater sensitivity in order to detect smaller targets (e.g., children, pets) than in a human-operated scenario. In order to achieve and maintain a high level of sensitivity, two parameters (phase noise and system characteristic colored noise) can be compensated. Phase noise is an intrinsic uncertainty parameter of the RADAR signal source. As phase noise increases, the radial, rotational and vibrational velocity sensitivity of the RADAR system is affected. The system characteristic colored noise is caused by the interfacing of different components in the RADAR sensor front end that cause the sensor to have a mixture of different noise types in its characteristic response.

Standard automotive radar system calibration techniques cannot calibrate or compensate these parameters (i.e., phase noise, system characteristic colored noise). The approach described herein can be used to increase the sensitivity of high-resolution radar sensors to detect potential targets of interest that cannot be detected by previous radar sensors.

Further, the approach described herein provides compact signal representation. By extracting the main components of the phase noise and system characteristic colored noise signals, a compact version of the main variation in the radar sensor can be efficiently transferred to the RADAR point cloud formation chain to compensate for the sensor level effects.

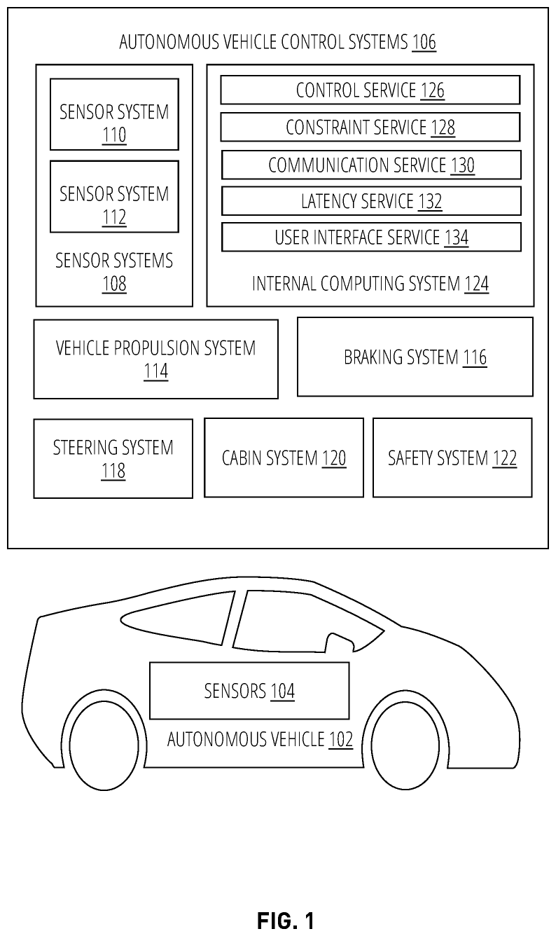

FIG. 1 is a block diagram of an example autonomous vehicle. Autonomous vehicle 102 has the functionality to navigate roads without a human driver by utilizing sensors 104 and autonomous vehicle control systems 106.

Autonomous vehicle 102 can include, for example, sensor systems 108 including any number of sensor systems (e.g., sensor system 110, sensor system 112). Sensor systems 108 can include various types of sensors that can be arranged throughout autonomous vehicle 102. For example, sensor system 110 can be a camera sensor system. As another example, sensor system 112 can be a light detection and ranging (LIDAR) sensor system. As a further example, one of sensor systems 108 can be a radio detection and ranging (RADAR) sensor system, an electromagnetic detection and ranging (EmDAR) sensor system, a sound navigation and ranging (SONAR) sensor system, a sound detection and ranging (SODAR) sensor system, a global navigation satellite system (GNSS) receiver system, a global positioning system (GPS) receiver system, accelerometers, gyroscopes, inertial measurement unit (IMU) systems, infrared sensor systems, laser rangefinder systems, microphones, etc.

In an example, the RADAR sensor systems of autonomous vehicle 102 are high-resolution RADAR systems that can utilize the approach described herein for real time (or near real time) calibration and compensation of phase noise and/or system characteristic colored noise. This can allow autonomous vehicle 102 to identify and react to smaller targets (e.g., pets, wildlife) that might not be detectable without the mechanisms described herein.

Autonomous vehicle 102 can further include mechanical systems to control and manage motion of autonomous vehicle 102. For example, the mechanical systems can include vehicle propulsion system 114, braking system 116, steering system 118, cabin system 120 and safety system 122. Vehicle propulsion system 114 can include, for example, an electric motor, an internal combustion engine, or both. Braking system 116 can include an engine brake, brake pads, actuators and/or other components to control deceleration of autonomous vehicle 102. Steering system 118 can include components that control the direction of autonomous vehicle 102. Cabin system 120 can include, for example, cabin temperature control systems, in-cabin infotainment systems and other internal elements.

Safety system 122 can include various lights, signal indicators, airbags, systems that detect and react to other vehicles. Safety system 122 can include one or more radar systems. Autonomous vehicle 102 can utilize different types of radar systems, for example, long-range radar (LRR), mid-range radar (MRR) and/or short-range radar (SRR). LRR systems can be used, for example, to detect objects that are farther away (e.g., 200 meters, 300 meters) from the vehicle transmitting the signal. LRR systems can operate in the 77 GHz band (e.g., 76-81 GHz). SRR systems can be used, for example, for blind spot detection or collision avoidance. SRR systems can operate in the 24 GHz band. MRR systems can operate in either the 24 GHz band or the 77 GHz band. Other frequency bands can also be supported.

Autonomous vehicle 102 can further include internal computing system 124 that can interact with sensor systems 108 as well as the mechanical systems (e.g., vehicle propulsion system 114, braking system 116, steering system 118, cabin system 120 and safety system 122). Internal computing system 124 includes at least one processor and at least one memory system that can store executable instructions to be executed by the processor. Internal computing system 124 can include any number of computing sub-systems that can function to control autonomous vehicle 102. Internal computing system 124 can receive inputs from passengers and/or human drivers within autonomous vehicle 102.

Internal computing system 124 can include control service 126, which functions to control operation of autonomous vehicle 102 via, for example, the mechanical systems as well as interacting with sensor systems 108. Control service 126 can interact with other systems (e.g., constraint service 128, communication service 130, latency service 132 and internal computing system 124) to control operation of autonomous vehicle 102.

Internal computing system 124 can also include constraint service 128, which functions to control operation of autonomous vehicle 102 through application of rule-based restrictions or other constraints on operation of autonomous vehicle 102. Constraint service 128 can interact with other systems (e.g., control service 126, communication service 130, latency service 132, user interface service 134) to control operation of autonomous vehicle 102.

Internal computing system 124 can further include communication service 130, which functions to control transmission of signals from, and receipt of signals by, autonomous vehicle 102. Communication service 130 can interact with safety system 122 to provide the waveform sensing, amplification and repeating functionality described herein. Communication service 130 can interact with other systems (e.g., control service 126, constraint service 128, latency service 132 and user interface service 134) to control operation of autonomous vehicle 102.

Internal computing system 124 can also include latency service 132, which functions to provide and/or utilize timestamp information on communications to help manage and coordinate time-sensitive operations within internal computing system 124 and autonomous vehicle 102. Thus, latency service 132 can interact with other systems (e.g., control service 126, constraint service 128, communication service 130, user interface service 134) to control operation of autonomous vehicle 102.

Internal computing system 124 can further include user interface service 134, which functions to provide information to, and receive inputs from, human passengers within autonomous vehicle 102. This can include, for example, receiving a desired destination for one or more passengers and providing status and timing information with respect to arrival at the desired destination. User interface service 134 can interact with other systems (e.g., control service 126, constraint service 128, communication service 130, latency service 132) to control operation of autonomous vehicle 102.

Internal computing system 124 can function to send and receive signals from autonomous vehicle 102 regarding reporting data for training and evaluating machine learning algorithms, requesting assistance from a remote computing system or a human operator, software updates, rideshare information (e.g., pickup and/or dropoff requests and/or locations), etc.

In some examples described herein autonomous vehicle 102 (or another device) may be described as collecting data corresponding to surrounding vehicles. This data may be collected without associated identifiable information from these surrounding vehicles (e.g., without license plate numbers, make, model, and the color of the surrounding vehicles). Accordingly, the techniques mentioned here can because for the beneficial purposes described, but without the need to store potentially sensitive information of the surrounding vehicles.

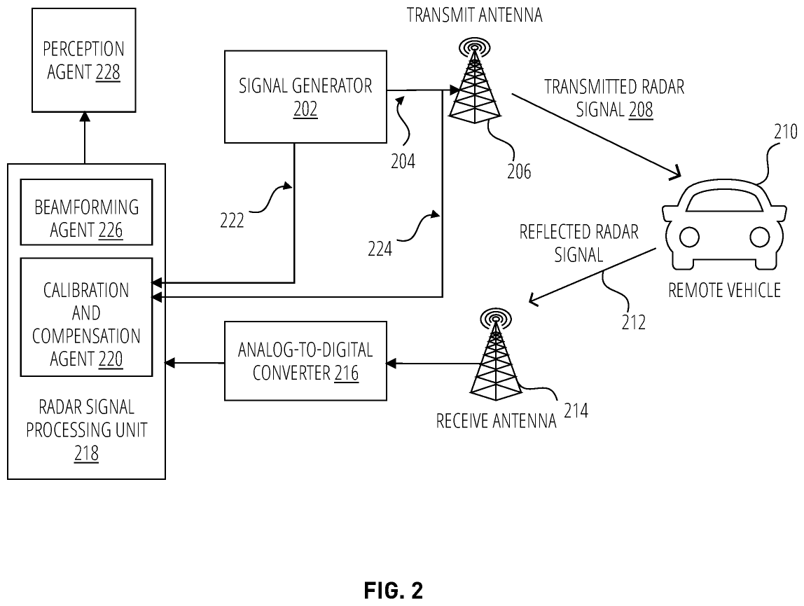

FIG. 2 a block diagram of an example automotive radar system illustrating transmit and receive capability. The radar system of FIG. 2 can be, for example, one of sensor systems 108 in autonomous vehicle 102. In other examples, the automotive radar system of FIG. 2 can be part of a human-operated vehicle having an ADAS that can utilize various sensors including radar sensors.

Signal generator 202 can be, for example, a frequency-modulated continuous wave (FMCW) generator that produces a series of chirps, which are sinusoid signals have frequencies that sweep from a pre-selected minimum frequency to a pre-selected maximum frequency to be transmitted from, for example, a host platform (e.g., autonomous vehicle 102, human operated ADAS vehicle, automated delivery vehicle). Other signal types (e.g., non-FMCW) can also be supported.

The signal generated by signal generator 202 provides a radar frequency signal (e.g., generated RADAR waveform 204) to be transmitted by transmit antenna 206 (which can be a single antenna or an antenna array) as transmitted RADAR signal 208. Transmitted RADAR signal 208 can be reflected by a remote object, for example, remote vehicle 210. Reflected radar signal 212 is detected by receive antenna 214, which can be a single antenna or an antenna array. The received reflected radar signal 212 from receive antenna 214 can be digitized by analog-to-digital converter 216 to generate digital RADAR waveforms that are transmitted to RADAR signal processing unit 218.

In an example, RADAR signal processing unit 218 includes calibration and compensation agent 220, which can provide the near field beamforming functionality described in greater detail below. Calibration and compensation agent 220 can provide real time (or near real time) near field RADAR beamforming functionality for RADAR signal processing unit 218. As described in greater detail below, this can be useful for sub-meter settings. RADAR signal processing unit 218 can provide information to perception agent 228, which can be utilized to control an autonomous vehicle or to provide driver feedback and/or assistance in an ADAS environment.

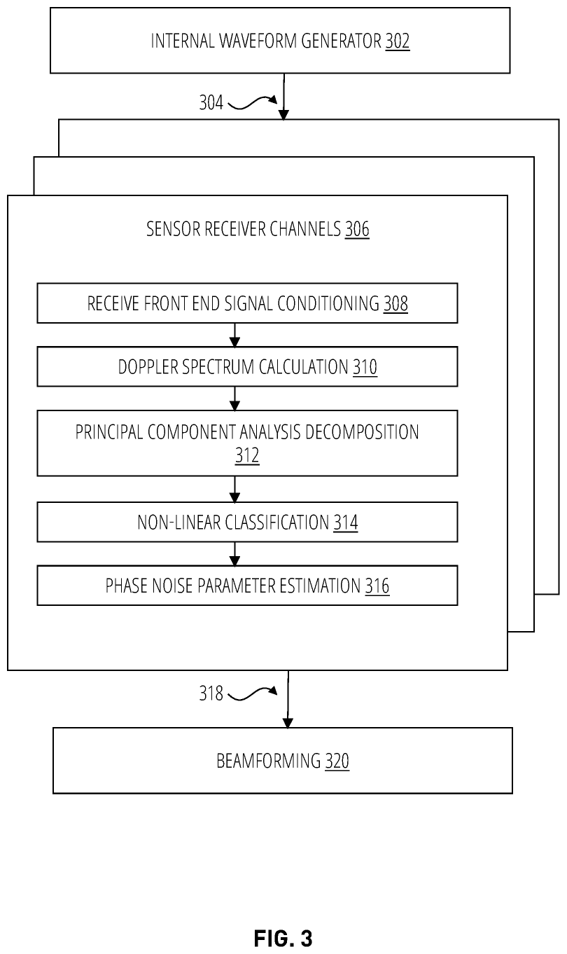

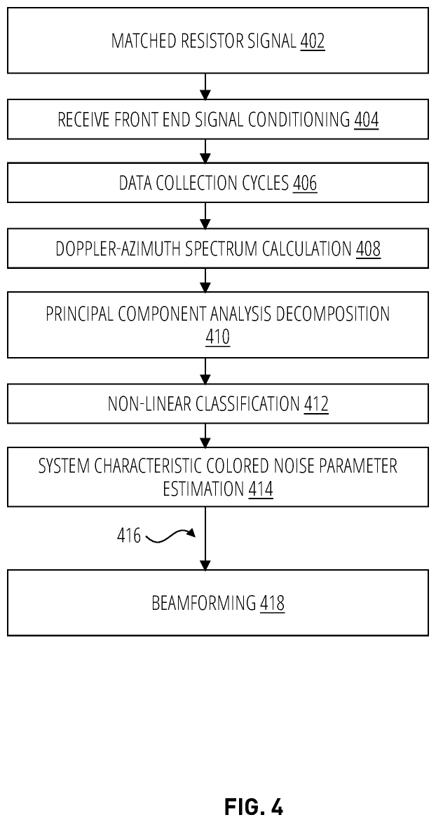

By receiving signal information from signal generator 202 (described in greater detail below), calibration and compensation agent 220 can provide calibration and compensation information for phase noise and/or system characteristic colored noise to be used in signal processing provided by RADAR signal processing unit 218. In an example, signal generator 202 can provide phase noise reference signal 222 (described in greater detail with respect to FIG. 3) to calibration and compensation agent 220. In an example, system characteristic colored noise reference signal 224 (described in greater detail with respect to FIG. 4) can be provided to calibration and compensation agent 220.

FIG. 3 is a block diagram of an architecture that can provide calibration and compensation of phase noise. The functionality of FIG. 3 can be provided by, for example, a RADAR sensor system within autonomous vehicle 102, as illustrated in FIG. 1. In other examples, the functionality of FIG. 3 can be provided by systems within a human-operated vehicle having an ADAS that can utilize various sensors including camera systems and radar sensors.

For phase noise calibration and compensation, internal waveform generator 302 output is switched to the receiver radio frequency (RF) from end entry point for reach sensor receiver channels 306 to provide reference signal 304 (e.g., phase noise reference signal 222) for use in calibration and compensation. In an example, reference signal 304 is the RADAR waveform to be transmitted by the RADAR sensor system as generated by a signal generator (e.g., signal generator 202). A pre-selected number (e.g., 5, 10, 45, 103) of cycles of reference signal 304 waveforms are collected (e.g., by calibration and compensation agent 220).

For each sensor receiver channels 306, receive front end signal conditioning 308 can be performed, if necessary. Various conditioning techniques can be applied through receive front end signal conditioning 308. Doppler spectrum calculation 310 is performed for the collected data. Any number of sensor receiver channels 306 can be supported.

Principal component analysis decomposition 312 (PCA) is performed to calculate a PCA model of the Doppler spectrum. Principal component analysis decomposition 312 allows for cross correlation of a signal to see if principal components are different over time intervals. This information can be used for signal compression and to extract important components of the signal.

The PCA coefficients are processed via non-linear classification 314 to determine the proper collection cycle parameters (e.g., number of waveforms, waveform duration) to maintain the desired baseline motion sensing sensitivity of the sensor through phase noise parameter estimation 316. In other approaches, non-linear classification can be used with a full point cloud only; however, use of non-linear classification with PCA analysis provides a unique application and significant advantages over previous approaches.

Collection cycle parameters 318 are then communicated to the point cloud formation chain for beamforming 320. In systems having multiple sensor receiver channels 306, collection cycle parameters 318 can be different for different channels.

By extracting the main components of the phase noise signal, a compact version of the main variations in the radar sensor can be efficiently transferred to the point cloud formation chain to compensate for the sensor-level effects. A series of calibration cycles can be schedule during the sensor operation in the platform to provide on-the-fly/real time (or near real time) calibration. In the example provided, the computational complexity of the PCA model is O(n) when implemented in a parallel computing platform, which supports the real time (or near real time) operation.

FIG. 4 is a block diagram of an architecture that can provide calibration and compensation of system characteristic colored noise. The functionality of FIG. 4 can be provided by, for example, a RADAR sensor system within autonomous vehicle 102, as illustrated in FIG. 1. In other examples, the functionality of FIG. 4 can be provided by systems within a human-operated vehicle having an ADAS that can utilize various sensors including camera systems and radar sensors.

In an example, the receiver radio frequency (RF) front end entry points are switched to a low-resistance (e.g., 50 Ohm) load path to provide matched resistor signal 402. In an example, the low-resistance load path is physically located as close to the transmit antenna a practically possible. Receive front end signal conditioning 404 can be performed on matched resistor signal 402. A pre-defined number of data collection cycles 406 are performed.

Doppler-azimuth spectrum calculation 408 is performed for the collected data. Principal component analysis decomposition 410 (PCA) is performed to calculate a PCA model of the Doppler-azimuth spectrum. Principal component analysis decomposition 410 allows for cross correlation of a signal to see if principal components are different over time intervals. This information can be used for signal compression and to extract important components of the signal.

The PCA coefficients are processed via non-linear classification 412 to determine the proper collection cycle parameters (e.g., number of waveforms, waveform duration) to properly maintain the baseline motion sensing sensitivity of the sensor through system characteristic colored noise parameter estimation 414. In other approaches, non-linear classification can be used with a full point cloud; however, use of non-linear classification with PCA analysis provides a unique application and significant advantages over previous approaches.

Collection cycle parameters 416 are then communicated to the point cloud formation chain for beamforming 418. By extracting the main components of the system characteristic colored noise signal, a compact version of the main variations in the radar sensor can be efficiently transferred to the point cloud formation chain to compensate for the sensor-level effects. A series of calibration cycles can be schedule during the sensor operation in the platform to provide on-the-fly/real time (or near real time) calibration. In the example provided, the computational complexity of the PCA model is O(n) when implemented in a parallel computing platform, which supports the real time (or near real time) operation.

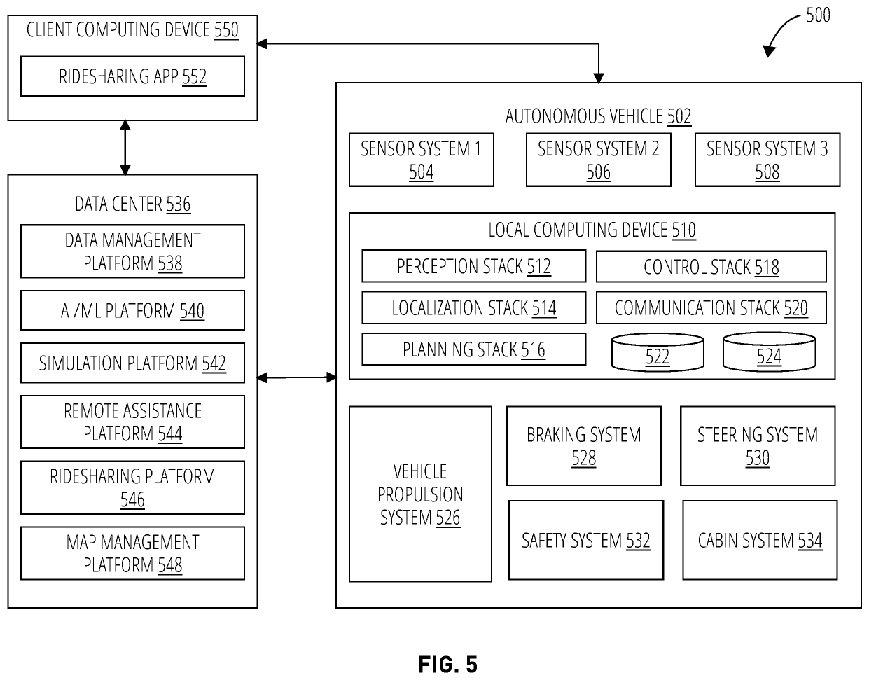

FIG. 5 illustrates an example autonomous vehicle management architecture. One of ordinary skill in the art will understand that, for the autonomous vehicle management architecture 500 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In an example, autonomous vehicle management architecture 500 includes autonomous vehicle 502, data center 536, and client computing device 550. Autonomous vehicle 502, data center 536, and client computing device 550 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

Autonomous vehicle 502 can navigate about roadways without a human driver based on sensor signals generated by multiple sensor systems 504, 506, and 326. Sensor systems 504, 506 and 508 can include different types of sensors and can be arranged about the autonomous vehicle 502. For instance, sensor systems 504, 506 and 508 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, sensor system 504 can be a camera system, sensor system 506 can be a LIDAR system, and sensor system 508 can be a RADAR system. Other examples may include any other number and type of sensors.

Autonomous vehicle 502 can also include several mechanical systems that can be used to maneuver or operate autonomous vehicle 502. For instance, the mechanical systems can include vehicle propulsion system 526, braking system 528, steering system 530, safety system 532, and cabin system 534, among other systems. Vehicle propulsion system 526 can include an electric motor, an internal combustion engine, or both. Braking system 528 can include an engine brake, a wheel braking system (e.g., a disc braking system that utilizes brake pads), hydraulics, actuators, and/or any other suitable componentry configured to assist in decelerating autonomous vehicle 502. Steering system 530 can include suitable componentry configured to control the direction of movement of the autonomous vehicle 502 during navigation. Safety system 532 can include lights and signal indicators, a parking brake, airbags, and so forth. Cabin system 534 can include cabin temperature control systems, in-cabin entertainment systems, and so forth.

In some examples, autonomous vehicle 502 may not include human driver actuators (e.g., steering wheel, handbrake, foot brake pedal, foot accelerator pedal, turn signal lever, window wipers, etc.) for controlling autonomous vehicle 502. Instead, cabin system 534 can include one or more client interfaces (e.g., Graphical User Interfaces (GUIs), Voice User Interfaces (VUIs), etc.) for controlling certain aspects of the mechanical systems (e.g., 526, braking system 528, steering system 530, safety system 532, cabin system 534).

Autonomous vehicle 502 can additionally include local computing device 510 that is in communication with sensor systems 504, 506 and 508, the mechanical systems, data center 536, and client computing device 550, among other systems. Local computing device 510 can include one or more processors and memory, including instructions that can be executed by the one or more processors. The instructions can make up one or more software stacks or components responsible for controlling autonomous vehicle 502; communicating with data center 536, client computing device 550, and other systems; receiving inputs from riders, passengers, and other entities within the AV's environment; logging metrics collected by sensor systems 504, 506 and 508; and so forth. In this example, local computing device 510 includes perception stack 512, mapping and localization stack 514, planning stack 516, control stack 518, communication stack 520, an High Definition (HD) geospatial database 522, and an autonomous vehicle operational database 342, among other stacks and systems.

Perception stack 512 can enable autonomous vehicle 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from sensor systems 504, 506 and 508, mapping and localization stack 514, HD geospatial database 522, other components of autonomous vehicle 502, and other data sources (e.g., data center 536, client computing device 550, third-party data sources, etc.). Perception stack 512 can detect and classify objects and determine their current and predicted locations, speeds, directions, and the like. In addition, perception stack 512 can determine the free space around autonomous vehicle 502 (e.g., to maintain a safe distance from other objects, change lanes, park the AV, etc.). Perception stack 512 can also identify environmental uncertainties, such as where to look for moving objects, flag areas that may be obscured or blocked from view, and so forth.

Mapping and localization stack 514 can determine the AV's position and orientation (pose) using different methods from multiple systems (e.g., GPS, IMUs, cameras, LIDAR, RADAR, ultrasonic sensors, the HD geospatial database 522, etc.). For example, in some examples, autonomous vehicle 502 can compare sensor data captured in real-time by the sensor systems 504, 506 and 508 to data in the HD geospatial database 522 to determine its precise (e.g., accurate to the order of a few centimeters or less) position and orientation. Autonomous vehicle 502 can focus its search based on sensor data from one or more first sensor systems (e.g., GPS) by matching sensor data from one or more second sensor systems (e.g., LIDAR). If the mapping and localization information from one system is unavailable, autonomous vehicle 502 can use mapping and localization information from a redundant system and/or from remote data sources.

Planning stack 516 can determine how to maneuver or operate autonomous vehicle 502 safely and efficiently in its environment. For example, planning stack 516 can receive the location, speed, and direction of autonomous vehicle 502, geospatial data, data regarding objects sharing the road with autonomous vehicle 502 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing autonomous vehicle 502 from one point to another.

Planning stack 516 can determine multiple sets of one or more mechanical operations that autonomous vehicle 502 can perform (e.g., go straight at a specified speed or rate of acceleration, including maintaining the same speed or decelerating; turn on the left blinker, decelerate if the autonomous vehicle is above a threshold range for turning, and turn left; turn on the right blinker, accelerate if the autonomous vehicle is stopped or below the threshold range for turning, and turn right; decelerate until completely stopped and reverse; etc.), and select the best one to meet changing road conditions and events.

If something unexpected happens, planning stack 516 can select from multiple backup plans to carry out. For example, while preparing to change lanes to turn right at an intersection, another vehicle may aggressively cut into the destination lane, making the lane change unsafe. Planning stack 516 could have already determined an alternative plan for such an event, and upon its occurrence, help to direct autonomous vehicle 502 to go around the block instead of blocking a current lane while waiting for an opening to change lanes.

Control stack 518 can manage the operation of vehicle propulsion system 526, braking system 528, steering system 530, safety system 532, and cabin system 534. Control stack 518 can receive sensor signals from sensor systems 504, 506 and 508 as well as communicate with other stacks or components of local computing device 510 or a remote system (e.g., data center 536) to effectuate operation of autonomous vehicle 502. For example, control stack 518 can implement the final path or actions from the multiple paths or actions provided by planning stack 516. This can involve turning the routes and decisions from planning stack 516 into commands for the actuators that control autonomous vehicle steering, throttle, brake, and drive unit.

Communication stack 520 can transmit and receive signals between the various stacks and other components of autonomous vehicle 502 and between autonomous vehicle 502, data center 536, client computing device 550, and other remote systems. Communication stack 520 can enable local computing device 510 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communication stack 520 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

In an example, HD geospatial database 522 can store HD maps and related data of the streets upon which autonomous vehicle 502 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

Autonomous vehicle operational database 524 can store raw autonomous vehicle data generated by sensor systems 504, 506 and 508 and other components of autonomous vehicle 502 and/or data received by autonomous vehicle 502 from remote systems (e.g., data center 536, client computing device 550, etc.). In some examples, the raw autonomous vehicle data can include point cloud data, image or video data, RADAR data, GPS data, and other sensor data that data center 536 can use for creating or updating autonomous vehicle geospatial data.

The point cloud data can be generated by a RADAR sensor system that has been calibrated using the approaches described herein. By using the realtime calibration techniques, the resulting point cloud data can be more accurate than point clouds generated using traditional approaches.

Data center 536 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. Data center 536 can include one or more computing devices remote to local computing device 510 for managing a fleet of autonomous vehicles and AV-related services. For example, in addition to managing autonomous vehicle 502, data center 536 may also support a ridesharing service, a delivery service, a remote/roadside assistance service, street services (e.g., street mapping, street patrol, street cleaning, street metering, parking reservation, etc.), and the like.

Data center 536 can send and receive various signals to and from autonomous vehicle 502 and client computing device 550. These signals can include sensor data captured by sensor systems 504, 506 and 508, roadside assistance requests, software updates, ridesharing pick-up and drop-off instructions, and so forth. In this example, data center 536 includes one or more of data management platform 538, Artificial Intelligence/Machine Learning (AI/ML) platform 540, simulation platform 542, remote assistance platform 544, ridesharing platform 546, and map management platform 548, among other systems.

Data management platform 538 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., autonomous vehicles, enterprise systems, social networks, etc.), data having different rates of change (e.g., batch, streaming, etc.), or data having other heterogeneous characteristics. The various platforms and systems of data center 536 can access data stored by data management platform 538 to provide their respective services.

AI/ML platform 540 can provide the infrastructure for training and evaluating machine learning algorithms for operating autonomous vehicle 502, simulation platform 542, remote assistance platform 544, ridesharing platform 546, map management platform 548, and other platforms and systems. Using AI/ML platform 540, data scientists can prepare data sets from data management platform 538; select, design, and train machine learning models; evaluate, refine, and deploy the models; maintain, monitor, and retrain the models; and so on.

Simulation platform 542 can enable testing and validation of the algorithms, machine learning models, neural networks, and other development efforts for autonomous vehicle 502, remote assistance platform 544, ridesharing platform 546, map management platform 548, and other platforms and systems. Simulation platform 542 can replicate a variety of driving environments and/or reproduce real-world scenarios from data captured by autonomous vehicle 502, including rendering geospatial information and road infrastructure (e.g., streets, lanes, crosswalks, traffic lights, stop signs, etc.) obtained from map management platform 548; modeling the behavior of other vehicles, bicycles, pedestrians, and other dynamic elements; simulating inclement weather conditions, different traffic scenarios; and so on.

Remote assistance platform 544 can generate and transmit instructions regarding the operation of autonomous vehicle 502. For example, in response to an output of AI/ML platform 540 or other system of data center 536, remote assistance platform 544 can prepare instructions for one or more stacks or other components of autonomous vehicle 502.

Ridesharing platform 546 can interact with a customer of a ridesharing service via ridesharing app 552 executing on client computing device 550. Client computing device 550 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing ridesharing app 552. Client computing device 550 can be a customer's mobile computing device or a computing device integrated with autonomous vehicle 502 (e.g., local computing device 510). Ridesharing platform 546 can receive requests to be picked up or dropped off from ridesharing app 552 and dispatch autonomous vehicle 502 for the trip.

Map management platform 548 can provide a set of tools for the manipulation and management of geographic and spatial (geospatial) and related attribute data. Data management platform 538 can receive point cloud data, image data (e.g., still image, video, etc.), RADAR data, GPS data, and other sensor data (e.g., raw data) from one or more autonomous vehicle 502, Unmanned Aerial Vehicles (UAVs), satellites, third-party mapping services, and other sources of geospatially referenced data. The raw data can be processed, and map management platform 548 can render base representations (e.g., tiles (2D), bounding volumes (3D), etc.) of the autonomous vehicle geospatial data to enable users to view, query, label, edit, and otherwise interact with the data.

Map management platform 548 can manage workflows and tasks for operating on the autonomous vehicle geospatial data. Map management platform 548 can control access to the AV geospatial data, including granting or limiting access to the AV geospatial data based on user-based, role-based, group-based, task-based, and other attribute-based access control mechanisms. Map management platform 548 can provide version control for the AV geospatial data, such as to track specific changes that (human or machine) map editors have made to the data and to revert changes when necessary. Map management platform 548 can administer release management of the autonomous vehicle geospatial data, including distributing suitable iterations of the data to different users, computing devices, autonomous vehicles, and other consumers of HD maps. Map management platform 548 can provide analytics regarding the autonomous vehicle geospatial data and related data, such as to generate insights relating to the throughput and quality of mapping tasks.

In some examples, the map viewing services of map management platform 548 can be modularized and deployed as part of one or more of the platforms and systems of data center 536. For example, AI/ML platform 540 may incorporate the map viewing services for visualizing the effectiveness of various object detection or object classification models, simulation platform 542 may incorporate the map viewing services for recreating and visualizing certain driving scenarios, remote assistance platform 544 may incorporate the map viewing services for replaying traffic incidents to facilitate and coordinate aid, ridesharing platform 546 may incorporate the map viewing services into ridesharing app 552 to enable passengers to view autonomous vehicle 502 in transit en route to a pick-up or drop-off location, and so on.

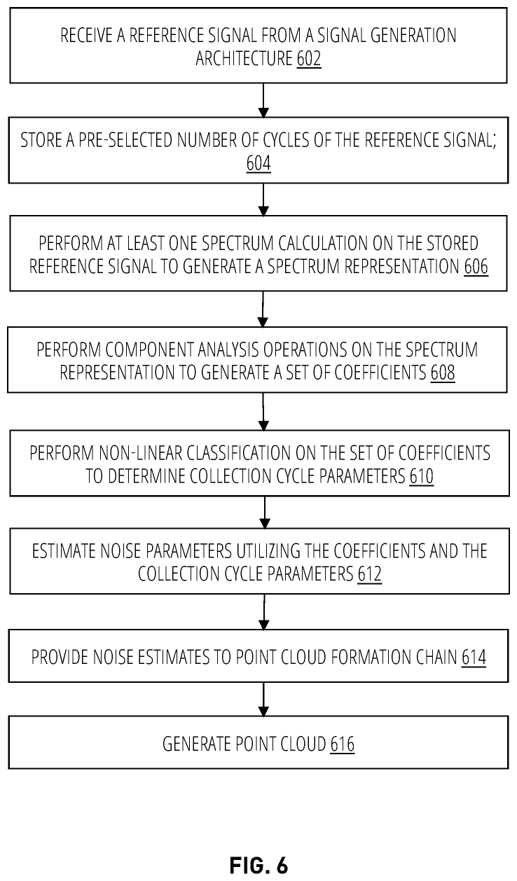

FIG. 6 is a flow diagram for one technique for calibration and compensation of noise in a RADAR system. The functionality of FIG. 6 can be provided by, for example, autonomous vehicle control systems 106 within autonomous vehicle 102, as illustrated in FIG. 1. In other examples, the functionality of FIG. 6 can be provided by systems within a human-operated vehicle having an ADAS that can utilize various sensors including camera systems and radar sensors.

A reference signal is received from a signal generation architecture, block 602. In examples where calibration and compensation are performed for phase noise, the reference signal is the waveform generated by the signal generator and is provided to the receiver signal processing architecture without being transmitted via the transmit antenna. That is the signal (e.g., generated RADAR waveform 204) generated by the signal generator (e.g., signal generator 202).

In examples where calibration and compensation are performed for system characteristic colored noise, the reference signal is received by the receiver signal processing architecture via a low-resistance path that provides the reference signal from a point as close to the transmit antenna as possible. Other locations, farther from the transmit antenna, can also be utilized with the cost of decreased system characteristic colored noise detection. In an example, both phase noise calibration and compensation, and system characteristic colored noise calibration and compensation can be supported in a single RADAR sensor system.

A pre-selected number of cycles of the reference signal are stored, block 604. The number of cycles stored can be different for phase noise estimation and for system characteristic colored noise estimation. For example, the phase noise estimation approach can utilize a first number (e.g., 5, 10, 15, 100) of stored reference signal cycles and the system characteristic colored noise approach can utilize a second number (e.g., 8, 16, 35, 40) of stored reference cycles.

The cycles that are stored can be stored during operation of the host autonomous vehicle to allow the calibration and compensation functionality to be performed periodically during operation. This allows the RADAR sensor systems to continuously adapt to changes caused by operating conditions without the need for autonomous vehicle downtime and/or removal of sensor system components from the autonomous vehicle.

One or more sets of spectrum calculations are performed on the stored reference signal to generate a spectrum representation, block 606. For phase noise estimation, Doppler spectrum calculations are performed. For system characteristic colored noise estimation, Doppler-azimuth spectrum calculations are performed.

perform component analysis operations on the spectrum representation to generate a set of coefficients, block 608. In an example principal component analysis (PCA) is performed on the results of the spectrum calculations. The PCA allows for cross correlation of a signal to see if principal components are different over time intervals. This information can be used for signal compression and to extract important components of the signal.

Non-linear classification is performed on the set of PCA coefficients to determine collection cycle parameters, block 610. Non-linear classification generally refers to models or groupings of data that have non-linear boundaries. In an example, the non-linear classification is applied to PCA coefficients generated from signal spectrum calculations.

Noise parameters utilizing the coefficients and the collection cycle parameters are estimated, block 612. In an example, the noise parameters characterize the phase noise as detected within the RADAR sensor system so that the system can be compensated to minimize (or eliminate) the detected phase noise using the approach described. In another example, the noise parameters characterize the system characteristic colored noise as detected within the RADAR sensor system so that the system can be compensated to minimize (or eliminate) the detected system characteristic colored noise using the approach described. In some examples, noise parameters for both phase noise and system characteristic colored noise can be generated and used to provide calibration and compensation of the RADAR sensor system.

The noise estimates are provided to the point cloud formation chain, block 614. The point cloud formation chain uses the noise estimates to generate a point cloud, block 616. Use of the noise estimates determined using the approach described allows for improved calibration and compensation based on current conditions, which can result in an improved point cloud. As mentioned above, the noise estimations can be performed during operation of an autonomous vehicle so that that RADAR systems of the autonomous vehicle are continually updated and calibrated.

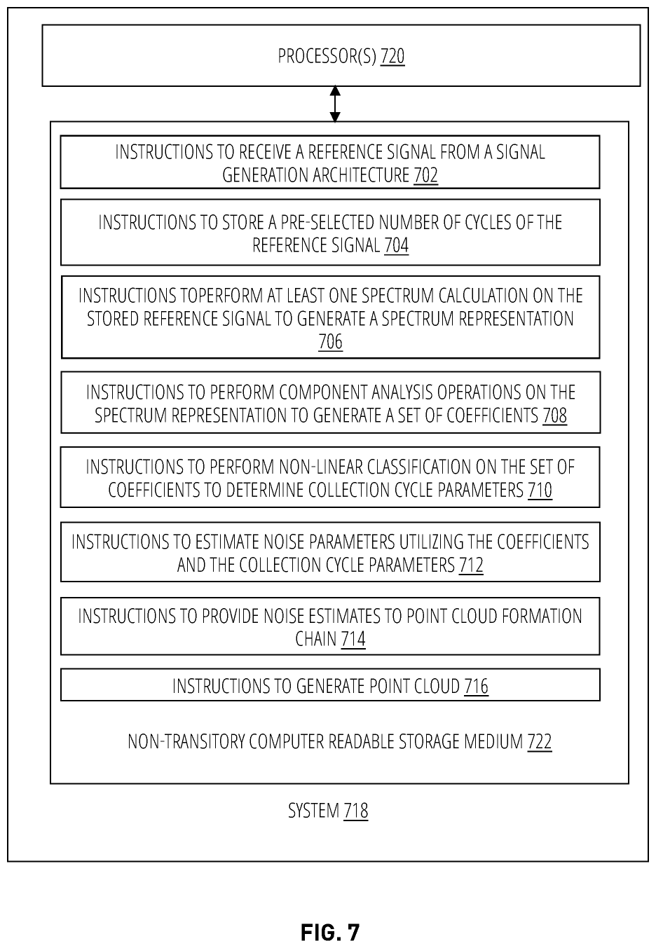

FIG. 7 is a block diagram of one example of a processing system that can provide calibration and compensation of noise in a RADAR system. In one example, system 718 can be part of an autonomous vehicle (e.g., autonomous vehicle 102 as part of internal computing system 124) that utilizes various sensors including radar sensors. In other examples, system 718 can be part of a human-operated vehicle having an advanced driver assistance system (ADAS) that can utilized various sensors including radar sensors.

In an example, system 718 can include processor(s) 720 and non-transitory computer readable storage medium 722. Non-transitory computer readable storage medium 722 may store instructions 702, 704, 708, 710, 712, 714, 716 and 718 that, when executed by processor(s) 720, cause processor(s) 720 to perform various functions. Examples of processor(s) 720 may include a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of a non-transitory computer readable storage medium 722 include tangible media such as random-access memory (RAM), read-only memory (ROM), electrically erasable programmable read-only memory (EEPROM), flash memory, a hard disk drive, etc.

Instructions 702 cause processor(s) 720 to receive a reference signal from a signal generation architecture. In examples where calibration and compensation are performed for phase noise, the reference signal is the waveform generated by the signal generator and is provided to the receiver signal processing architecture without being transmitted via the transmit antenna. That is the signal (e.g., generated RADAR waveform 204) generated by the signal generator (e.g., signal generator 202).

In examples where calibration and compensation are performed for system characteristic colored noise, the reference signal is received by the receiver signal processing architecture via a low-resistance path that provides the reference signal from a point as close to the transmit antenna as possible. Other locations, farther from the transmit antenna, can also be utilized with the cost of decreased system characteristic colored noise detection. In an example, both phase noise calibration and compensation, and system characteristic colored noise calibration and compensation can be supported in a single RADAR sensor system.

Instructions 704 cause processor(s) 720 to store a pre-selected number of cycles of the reference signal. The number of cycles stored can be different for phase noise estimation and for system characteristic colored noise estimation. For example, the phase noise estimation approach can utilize a first number (e.g., 5, 10, 15, 100) of stored reference signal cycles and the system characteristic colored noise approach can utilize a second number (e.g., 8, 16, 35, of stored reference cycles.

The cycles that are stored can be stored during operation of the host autonomous vehicle to allow the calibration and compensation functionality to be performed periodically during operation. This allows the RADAR sensor systems to continuously adapt to changes caused by operating conditions without the need for autonomous vehicle downtime and/or removal of sensor system components from the autonomous vehicle.

Instructions 706 cause processor(s) 720 to perform at least one spectrum calculation on the stored reference signal to generate a spectrum representation. For phase noise estimation, Doppler spectrum calculations are performed. For system characteristic colored noise estimation, Doppler-azimuth spectrum calculations are performed.

Instructions 708 cause processor(s) 720 to . . . perform component analysis operations on the spectrum representation to generate a set of coefficients. In an example, PCA is performed on the results of the spectrum calculations. The PCA allows for cross correlation of a signal to see if principal components are different over time intervals. This information can be used for signal compression and to extract important components of the signal.

Instructions 710 cause processor(s) 720 to perform non-linear classification on the set of coefficients to determine collection cycle parameters. Non-linear classification generally refers to models or groupings of data that have non-linear boundaries. In an example, the non-linear classification is applied to PCA coefficients generated from signal spectrum calculations.

Instructions 712 cause processor(s) 720 to estimate noise parameters utilizing the coefficients and the collection cycle parameters. In an example, the noise parameters characterize the phase noise as detected within the RADAR sensor system so that the system can be compensated to minimize (or eliminate) the detected phase noise using the approach described. In another example, the noise parameters characterize the system characteristic colored noise as detected within the RADAR sensor system so that the system can be compensated to minimize (or eliminate) the detected system characteristic colored noise using the approach described. In some examples, noise parameters for both phase noise and system characteristic colored noise can be generated and used to provide calibration and compensation of the RADAR sensor system.

Instructions 714 cause processor(s) 720 to provide noise estimates to point cloud formation chain. Instructions 716 cause processor(s) 720 to generate a point cloud using the noise estimates. Use of the noise estimates determined using the approach described allows for improved calibration and compensation based on current conditions, which can result in an improved point cloud. As mentioned above, the noise estimations can be performed during operation of an autonomous vehicle so that that RADAR systems of the autonomous vehicle are continually updated and calibrated.

In the description above, for the purposes of explanation, numerous specific details are set forth in order to provide a thorough understanding of the described examples. It will be apparent, however, to one skilled in the art that examples may be practiced without some of these specific details. In other instances, well-known structures and devices are shown in block diagram form. There may be intermediate structures between illustrated components. The components described or illustrated herein may have additional inputs or outputs that are not illustrated or described.

Various examples may include various processes. These processes may be performed by hardware components or may be embodied in computer program or machine-executable instructions, which may be used to cause processor or logic circuits programmed with the instructions to perform the processes. Alternatively, the processes may be performed by a combination of hardware and software.

Portions of various examples may be provided as a computer program product, which may include a non-transitory computer-readable medium having stored thereon computer program instructions, which may be used to program a computer (or other electronic devices) for execution by one or more processors to perform a process according to certain examples. The computer-readable medium may include, but is not limited to, magnetic disks, optical disks, read-only memory (ROM), random access memory (RAM), erasable programmable read-only memory (EPROM), electrically erasable programmable read-only memory (EEPROM), magnetic or optical cards, flash memory, or other type of computer-readable medium suitable for storing electronic instructions. Moreover, examples may also be downloaded as a computer program product, wherein the program may be transferred from a remote computer to a requesting computer. In some examples, non-transitory computer readable storage medium 722 has stored thereon data representing sequences of instructions that, when executed by a processor(s) 720, cause the processor(s) 720 to perform certain operations.

Reference in the specification to “an example,” “one example,” “some examples,” or “other examples” means that a particular feature, structure, or characteristic described in connection with the examples is included in at least some examples, but not necessarily all examples. Additionally, such feature, structure, or characteristics described in connection with “an example,” “one example,” “some examples,” or “other examples” should not be construed to be limited or restricted to those example(s), but may be, for example, combined with other examples. The various appearances of “an example,” “one example,” or “some examples” are not necessarily all referring to the same examples.

What is claimed is:

1. A radio detection and ranging (RADAR) system comprising:
a vehicle control system coupled with the sensor systems and with the kinematic control systems, the vehicle control system to:
receive a reference signal from a signal generation architecture;
store a pre-selected number of cycles of the reference signal;
perform at least one spectrum calculation on the stored reference signal to generate a spectrum representation;
perform component analysis operations on the spectrum representation to generate a set of coefficients;
perform non-linear classification on the set of coefficients to determine collection cycle parameters; and
estimate noise parameters utilizing the coefficients and the collection cycle parameters.

2. The RADAR system of claim 1, wherein the reference signal comprises a RADAR signal to be transmitted via a transmission antenna.

3. The RADAR system of claim 2, wherein the spectrum calculation comprises a Doppler spectrum calculation.

4. The RADAR system of claim 1, wherein the reference signal comprises a signal received via a low-resistance path from close proximity to a transmission antenna.

5. The RADAR system of claim 4, wherein the spectrum calculation comprises a Doppler-azimuth spectrum calculation.

6. The RADAR system of claim 1, wherein the component analysis comprises principal component analysis.

7. The RADAR system of claim 1, wherein the noise parameters comprise estimated phase noise.

8. The RADAR system of claim 1, wherein the noise parameters comprise estimated system characteristic colored noise.

9. A non-transitory computer-readable medium having stored thereon instructions that, when executed by one or more processors, are configurable to cause the processors to:
receive a reference signal from a signal generation architecture;
store a pre-selected number of cycles of the reference signal;
perform at least one spectrum calculation on the stored reference signal to generate a spectrum representation;
perform component analysis operations on the spectrum representation to generate a set of coefficients;
perform non-linear classification on the set of coefficients to determine collection cycle parameters; and
estimate noise parameters utilizing the coefficients and the collection cycle parameters.

10. The non-transitory computer-readable medium of claim 9 wherein the reference signal comprises a RADAR signal to be transmitted via a transmission antenna.

11. The non-transitory computer-readable medium of claim 10 wherein the spectrum calculation comprises a Doppler spectrum calculation.

12. The non-transitory computer-readable medium of claim 9 wherein the reference signal comprises a matched resistor signal received via a low-resistance path from close proximity to a transmission antenna.

13. The non-transitory computer-readable medium of claim 12 wherein the spectrum calculation comprises a Doppler-azimuth spectrum calculation.

14. The non-transitory computer-readable medium of claim 9 wherein the component analysis comprises principal component analysis.

15. The non-transitory computer-readable medium of claim 9 wherein the noise parameters comprise estimated phase noise.

16. The non-transitory computer-readable medium of claim 9 wherein the noise parameters comprise estimated system characteristic colored noise.

17. A system comprising:
a memory system; and
one or more hardware processors coupled with the memory system, the one or more processors to:
receive a reference signal from a signal generation architecture;
store a pre-selected number of cycles of the reference signal;
perform at least one spectrum calculation on the stored reference signal to generate a spectrum representation;
perform component analysis operations on the spectrum representation to generate a set of coefficients;
perform non-linear classification on the set of coefficients to determine collection cycle parameters; and
estimate noise parameters utilizing the coefficients and the collection cycle parameters.

18. The system of claim 17 wherein the reference signal comprises a RADAR signal to be transmitted via a transmission antenna.

19. The system of claim 18 wherein the spectrum calculation comprises a Doppler spectrum calculation.

20. The system of claim 17 wherein the reference signal comprises a matched resistor signal received via a low-resistance path from close proximity to a transmission antenna.

21. The system of claim 20 wherein the spectrum calculation comprises a Doppler-azimuth spectrum calculation.

22. The system of claim 17 wherein the component analysis comprises principal component analysis.

23. The system of claim 17 wherein the noise parameters comprise estimated phase noise.

24. The system of claim 17 wherein the noise parameters comprise estimated system characteristic colored noise.
